(19) United States
(12) Patent Application Publication
(10) Pub. No.: US 2026/0348759 A1
(43) Pub. Date: Nov. 5, 2026

(54) OPTICAL CAMERA SENSOR, CAMERA SYSTEM AND METHOD FOR MULTI-SPECTRAL LIGHT SENSING

(71) Applicant: ams-OSRAM AG, Premstaetten (AT)

(72) Inventors: Gunter SIEß, Kraftsdorf (DE); Mahmoud JAZAYERI FAR, Jena (DE); Julius KOMMA, Jena (DE)

(21) Appl. No.: 19/485,181

(22) PCT Filed: May 16, 2024
(86) PCT No.: PCT/EP2024/063577

§ 371 Date: Nov. 17, 2025

(30) Foreign Application Priority Data
May 17, 2023 (DE) 10 2023 113 097.8

(51) Int. Cl. G01J 3/02; G01J 1/42; G01J 3/28

(52) U.S. Cl. CPC G01J 3/0289; G01J 1/4204; G01J 3/2803

(57) ABSTRACT

An optical camera sensor comprising an array of camera sensor pixels each generating an irradiance sensor signal, shall be optimized for superior functionality and versatility. For this purpose, the irradiance sensor signals generated by the camera sensor pixels are provided for generation of a parameter characteristic for an angle of incidence (AOI) of the irradiance of the camera sensor.

### TECHNICAL BACKGROUND OF THE INVENTION

The invention relates to an optical camera sensor. The invention further relates to a camera system, and more particularly relates to a camera system comprising a camera sensor unit having an optical camera sensor, a functional sensor unit having an optical multispectral functional sensor, in particular an ambient light sensor, and a control unit. The invention furthermore relates to a method for multispectral light sensing.

### BACKGROUND

Optical sensors are increasingly being used in such diverse areas of technology as smart phones and mobile devices, smart homes and buildings, industrial automation, medical technology and connected vehicles, etc. At the same time sensor data becomes more complex and is expected to meet the requirements for high accuracy. Further, color and spectral light sensing on a chip-scale have various applications in color identification, data authentication, spectroscopy, and other industrial and consumer-level optical detection applications. In a number of important applications, in particular for camera applications, such sensors are used as ambient light sensors for so-called “auto white balance” functionality, in order to provide essential background information for appropriate correction functionalities and thereby in general improve imaging quality.

Common multispectral sensors are often based on an array of pixels and on-pixel filters for each pixel. For spectroscopic applications the filters can be chosen to have linear independent filter characteristics. In order to accomplish an accurate spectral measurement of a given source, the angle of incidence (AOI) of incoming radiation should be known in order to compensate for different response of individual filters. This way an amplitude of a spectral signal of a pixel can be used to calculate a spectral reconstruction of a light source under study.

In order to properly interpret and calibrate the output of the ambient light sensor it is usually assumed that the sensor filter has a constant response in wavelength domain while in fact it depends on the angle of incidence (AOI). However, a homogenous distribution of incoming radiation on the pixel array is an ideal condition. Further, the spectral sensitivity of an interference filter-based multispectral sensor depends strongly on the angular distribution of light hitting the filter on the detector array. The dependency of sensor characteristics on AOI is usually mitigated by diffusers on top pf the senor, but the diffuser has also its own problems and limitations. In particular for uses in ambient light sensor devices, homogeneity of incoming light distribution may be of special significance, and in order to provide highly reliable homogenous distribution, such diffusers may be used in a position before incoming radiation reaches the pixels in order to mix the incoming light as well as possible and to pass on the light to the sensor array in a homogenous, ideally in a Lambertian, manner.

In general, in ambient light sensor systems, such a setup and the use of an (almost) Lambertion-type diffuser is expected to provide reliable relative measurement values between individual channels of the sensor, independently of the direction or angle of incoming light. Due to this reliable measurement of the respective spectral channel ratios, correct spectral reconstruction for proper characterization of incoming radiation will be possible, independently of the angle of irradiation. This per se will not be true, however, for measurement values for the total quantity of incoming radiation, or irradiance, or lux, which may depend strongly on the tilt angle of the respective device with respect to incoming radiation, in particular the so-called chief ray angle (“CRA”) or angle of incidence (“AOI”). This global value characteristic for the intensity of incoming light may be relevant for further signal processing, however, and the absolute value of irradiance detection will decrease by a cosine function for typical de-signs and layouts of the detector channels. In particular, typical wearable or handheld devices such as smart watches or mobile phones will tilt anytime and for applications in such devices the accuracy for Lux measurement etc will provide wrong out-put values.

Further, depending on the performance of an associated diffuser the system accuracy may also depend on the type and position of a dominant radiation spot. A wide diffuser object will scatter the light more homogeneous to the inside into the detector array than a dominant and small point. Typically, each diffuser with a common transmittance ratio also has an ideal Lambertian spread and will also vary the power distribution depending on the position (tilt vs. detector) and spectra sensitivity. The knowledge about the setup depending on spectra sensitivity is important to generate a useful transfer matrix for spectral reconstruction.

In summary, even though diffusers are common to generate an always similar angular distribution, those diffusers are an additional cost factor in the production lines of such sensors, and the different orientation/tilt of sensor can give a cosine error in radiation value.

### SUMMARY

The object of the invention is therefore to provide an improved sensor unit of the type identified above, comprising an optical sensor with an array of detector elements or pixels, that helps overcome the deficiencies identified above in a particular cost-saving manner. Further, an improved multi-spectral sensor should be provided, as well as an improved method for multispectral light sensing.

With respect to the optical camera sensor comprising an array of camera sensor pixels, each generating an irradiance sensor signal, this object is achieved in that the irradiance sensor signals generated by the camera sensor pixels are provided for generation of a parameter characteristic for an angle of incidence (AOI) of the irradiance of the camera sensor.

Preferred embodiments are subject of the dependent claims.

The invention is based on the basic consideration that in order to overcome the potential deficiencies identified above and to provide a functional sensor, in particular an ambient light sensor, with improved performance at reduced cost, solution should be found that allows for eliminating the need for providing a diffuser to the functional sensor, or at least to allow for reduced performance requirements for such diffuser. In order to allow for proper replacement functionality in order to keep the sensor output signals at high reliability level nevertheless, a dedicated setup for determination or estimation of an AOI should be provided, in order to allow for mathematical recalibration of the sensor performance in dependence on the respective AOI. According to the general approach of the present invention, such a parameter for identification or at least estimation of an AOI may be provided by using the camera image or camera sensor output as such to estimate the incoming light AOI and use this AOI information to improve the calibration of the ambient light sensor.

It is noted that within one aspect of the invention, the AOI may be understood as the main AOI, characteristic for the overall light situation. In another embodiment, and within another aspect of the present invention, however, it may alternatively be any AOI, potentially also characteristic for only part of the illumination situation, for a particular dominant source of radiation, or the like. Within the scope of the present invention, a significant benefit of using the camera data for this analysis is that a histogram of all angular distributions of incoming radiation can be created. For the compensation of the sensor, all types of angular distributions may be of interest, which can also include several sources of radiation at different angles to the axis.

In accordance with an aspect of the invention, an optical camera sensor generating the irradiance sensor signals may be integrated into an optical camera sensor unit and further and in addition to the camera sensor comprising a control unit, wherein the control unit is arranged to calculate the parameter characteristic for an angle of incidence of the irradiance of the camera sensor from irradiance sensor signals generated by at least some of said camera sensor pixels.

In yet another aspect of the invention, the information obtained by the irradiance sensor signals regarding the AOI or an estimated value therefore may be used to improve the calibration of a functional sensor, in particular an ambient light sensor, in a camera system. Such an integrated system is considered particularly beneficial, since the camera sensor is provided anyway, in order to perform other functionalities, and therefore the desired parameters characterizing the AOI may be provided as an additional functionality of the Camera sensor in the way of a “by-product”.

Accordingly, in this aspect the present invention suggests a camera system comprising a camera sensor unit, in particular of the type identified above, having an optical camera sensor, a functional sensor unit, having an optical multispectral functional sensor, and a control unit, wherein:
the optical camera sensor comprises an array of camera sensor pixels, each generating an irradiance sensor signal,
the optical functional sensor comprises an array of functional sensor pixels, wherein the functional sensor pixels each have a different spectral transmission characteristic, each generating a multi-spectral sensor signal, respectively, and wherein the control unit is arranged to calculate a compensation parameter for each of the functional sensor pixels from irradiance sensor signals generated by at least some of said camera sensor pixels. These signals, in a preferred embodiment, then can be processed to calculate a compensation parameter for each of the sensor pixels.

Calculation of said compensation parameters in an aspect of the invention may be executed in an external calculation or computation device. In a preferred embodiment and in accordance with one embodiment of the invention, with a particularly compact and versatile setup, however, the camera system as such is configured to provide sensor signals in such a “compensated mode”. In this preferred embodiment, the control unit further is arranged to modify the multispectral sensor signal generated by each of the functional sensor pixels by the compensation parameter calculated for the respective pixel in order to obtain a compensated multispectral sensor signal for each functional sensor pixel.

In an aspect of the invention, the recalibration of the functional sensor in dependence of the detected or estimated AOI is intended to completely replace any diffuser in the context of the functional sensor, such that the functional sensor unit may be designed “diffuser-free”, i.e. without the need to provide any diffuser at all. In another embodiment, however, the functional sensor unit may further comprise a diffuser arranged on top of an aperture on a housing with a chamber, in which the functional sensor is arranged. In such arrangement, the information gathered from the irradiance sensor values identifying the AOI may be used to improve or optimize diffuser performance even if such diffuser is working in suboptimal range or with other design priorities such as transparency.

In a preferred embodiment, at least the functional sensor pixels each comprise a photodiode and a filter, wherein the filter determines the transmission characteristic of the respective sensor pixel.

In a preferred embodiment, the multispectral sensor system is designed as an ambient light sensor.

With respect to the method for multispectral light sensing, the object identified above in accordance with one aspect of the invention is achieved with the steps of:
detecting received photons by means of an optical camera sensor,
   wherein the optical camera sensor comprises an array of camera sensor pixels,
for each camera sensor pixel, generating an irradiance sensor signal,
detecting received photons by means of an optical multi-spectral functional sensor,
   wherein the optical multispectral functional sensor comprises an array of functional sensor pixels each having a different spectral transmission characteristic,
for each functional sensor pixel, generating a multispectral sensor signal, and
calculating a compensation parameter for each of the functional sensor pixels from irradiance sensor signals generated by at least some of said camera sensor pixels.

In a preferred embodiment, the method further comprises the steps of
modifying the multispectral sensor signal generated by each of the functional sensor pixels by the compensation parameter calculated for the respective pixel, and
providing the modified multispectral sensor signals as out-put signals of a functional sensor unit.

In yet another preferred embodiment, the method further comprises the step of generating a parameter characteristic for an angle of incidence (AOI) of the irradiance of the camera sensor from the irradiance sensor signals generated by the camera sensor pixels.

In one aspect of the invention, the method as defined above is used in an application for ambient light sensing, preferably in camera applications. In one aspect the present invention also suggests a camera system, preferably in a smartphone or a wearable device, comprising an ambient light sensor having an optical detector unit of the type identified above.

The major advantages achieved by the invention may be seen in that due to the basic concept of the invention of using the digital camera sensor of a camera system to also provide parameters characteristic for the angle of incidence (AOI) of irradiation on the camera sensor allows for a specifically cost-efficient design of functionality sensors such as ambient light sensors, in which provision of a diffuser is not necessary, and the spectral reconstruction matrix can be optimized, in the way of recalibrating the sensor, by taking into account the parameters characteristic for the AOI.

### BRIEF DESCRIPTION OF THE PREFERRED EMBODIMENTS

Preferred embodiments and aspects of the invention are described further in connection with a drawing. In this drawing, the only FIG. shows a camera system, in particular for use in a smartphone, in cross section.

### DETAILED DESCRIPTION OF THE PREFERRED EMBODIMENTS

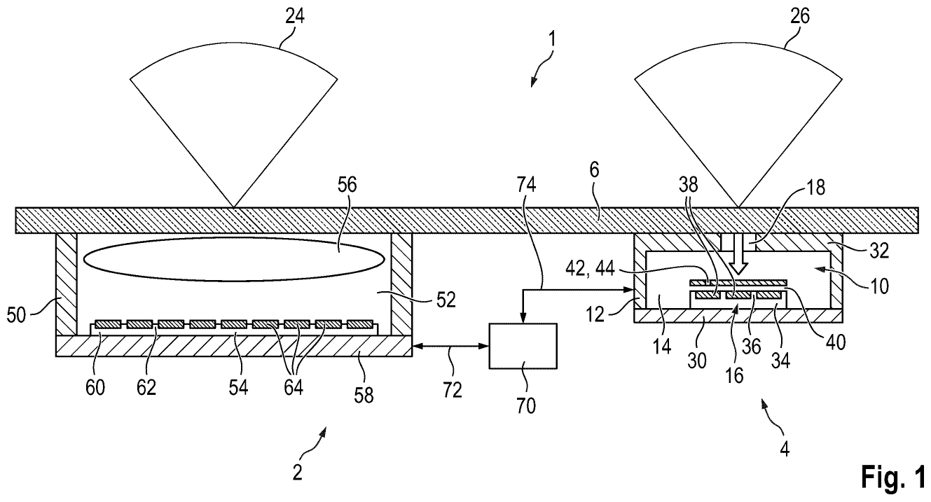

FIG. 1 shows an example of a camera system 1 in cross section that in the embodiment shown is integrated into a mobile device such as a smartphone. The camera system 1, as its major components, comprises the actual optical camera sensor unit 2 and an ambient light sensor 4 associated therewith. The camera sensor system 2 and the ambient light sensor 4 are mounted at the back of a common cover glass 6, which may be the cover glass 6 of the smartphone as such. The ambient light sensor 4 is used mainly for so-called “auto white balance” functionality in the camera system 1, in order to provide essential background information for appropriate correction functionalities and thereby in general improve imaging quality of the camera system 1.

The ambient light sensor 4 comprises a functional sensor unit 10 in the form and design of an optical multispectral sensor chip. It is noted that the concept proposed herein can be ap-plied for various types of functional sensor chips and optical devices and that the present invention relates to the design of the camera system 1 alone and therefore, within the scope of the present invention, may very well be used with a functional sensor unit 4 in other applications as in ambient light sensors 4.

The functional sensor unit 10 of the ambient light sensor 4 comprises a housing 12 with a sensor chamber 14 in which the actual optical multispectral functional sensor 16 is positioned. In order to allow for proper passage of light or radiation to reach the optical multispectral functional sensor 16 through the housing 12, the housing 12 is provided with an opening or aperture 18. For sake of illustration, the field of view of the camera sensor unit 2 and the field of view of the ambient light sensor 4 are also shown in FIG. 1, symbolized as cones 24, 26, respectively. In a preferred aspect of the invention, the field of view of the camera sensor unit 2 may be chosen larger than that of the ambient light sensor 4; and in such preferred embodiment the cone angle of the cone 24 associated with the camera sensor unit 2 should be larger than the cone angle of the cone 26 associated with the ambient light sensor 4.

The housing 12 of the functional sensor unit 10 of the ambient light sensor 4 is arranged on a substrate or carrier 30. A cover section or lid 32 forming the aperture 18 and also part of the housing 12, is located opposite to the carrier 30 and thereby covers the chamber 14. The carrier or substrate 30 provides mechanical support and electrical connectivity to electronic components which are integrated into the functional sensor unit 10. For example, the carrier 30 may comprise a printed circuit board, PCB (not shown). However, in other embodiments (not shown) the carrier 30 can also be part of the housing 12, and electronic components may be embedded into the housing 12 by molding for example. In yet an alternative embodiment, the circuitry may be designed in TSV technology (“through silicon via”). A through-chip via is a vertical electrical connection (via) that passes completely through a silicon wafer or die. The contacting of the chip in this technology is brought to the backside of the chip and processed as a BGA (ball grid array). The advantage is that everything may be mounted at wafer level (Si, filter, glass, optic, aperture, diffuser).

As part of the functional sensor unit 10, the optical multi-spectral functional sensor 16 is arranged inside the chamber 14 and on the carrier 30. In this particular embodiment, the optical sensor 16 is integrated into a single semiconductor sensor die 34 together with other electronics. The optical sensor comprises an array 36 of individual optical detector elements or pixels 38 which will be discussed in further de-tail below. The pixels 38 may be implemented as photodiodes, for example.

As further part of the functional sensor unit 10, an array 40 of optical filters 42 is arranged in the chamber 14 above the optical multispectral functional sensor 16. The array 40 of optical filters 42 is attached to the functional sensor 16. The pixels 38 each are associated with an associated optical filter 42 having a different transmission characteristic. Together the pixels 38 and associated filters 42 form a channel 44 of the functional sensor unit 10. The optical filters 42 determine the transmission characteristic of the respective sensor pixel 38 and the respective channel 44; they may be interference filters such as an optical cut-off filter, band-pass, long or short pass filter, dielectric filters, Fabry-Perot filters and/or polymer filters.

In order to allow for proper passage of light or radiation, the cover or lid 32 of the housing 12 is provided with the aperture 18. The aperture 18 is positioned above the funtional sensor 16. In fact, the aperture 18 lies within a field of view (FOV) of the optical sensor 16. The field of view of the optical sensor 16 includes all points in space from where, at least theoretically, light radiated from an external radiation or light source may traverse towards the optical sensor 16, e.g. for a fixed detector position and orientation.

A control unit and/or a measurement unit (not shown) may be integrated into the semiconductor sensor die 34 alongside with the optical functional sensor 16. The measurement unit can be considered a control unit for the optical functional sensor unit 10. For example, it may provide sensor signals which are generated by the optical functional sensor 16. The control unit and/or the measurement unit may be implemented as control logic, state machines, microprocessor and the like. They may also comprise additional components such as analog-to-digital converters, time-to-digital converters, amplifiers which too are located in the semiconductor sensor die 34. The semiconductor die 34 may have a printed circuit board PCB providing electrical communication to the individual components of the multispectral sensor. In operation, incoming radiation can be detected entering through the aperture 18 by means of the multispectral sensor 16. Each sensor pixel 38 in reaction generates a multispectral sensor signal, respectively. The measurement unit therefore in total provides a set of multispectral sensor signals.

In general, the accuracy and reliability of the output signals provided by the multispectral sensor 16 may be limited and lowered by a number of factors. In particular, both static and dynamic sources for potential errors in the signals may be of relevance. As an example of static sources for such errors, geometry factors may become relevant. More precisely, the spectral sensitivity of an interference filter based multispectral sensor as used in the embodiment shown depends strongly on the angular distribution of light hitting the respective filter 42 on the detector array 36. Static effects, such as misalignments of the centre of the sensor die 34 with respect to the aperture 18 in the lid, e. g., may be compensated by a transfer matrix used for spectral reconstruction.

As another source of potential errors or misreadings of the pixels 38, aspects such as tilt or angular displacement of the sensor arrangement relative to the dominant radiation or light source should be considered as well as effects created by the radiation or light source as such. In general, colour and spectral sensors for ambient light measurement are equipped with a diffuser on or before the aperture 18, which aims at evenly distributing incoming radiation into the interior of the chamber 14. When a diffuser is used in a sensor, it will be assumed that the sensor filters have constant responses in wavelength domain. These responses are saved in a calibration file which is used by the calibration software to convert the sensor output to meaningful spectral or color information. Typically, ideal, “Lambertian” diffusers may be used to generate constant angular distribution of light arriving at the detector array of such multispectral sensor unit 10. This provides fairly accurate sensor signals for the ratios of individual spectral channels, and consequently proper and reliable spectral reconstruction is nearly independent from angular conditions in the object field. This may be not the case, however, for absolute values, of sensor signals, representing a value of total irradiance or lux, which may be significantly dependent on the angle of incidence of incoming light, which may vary depending on tilting the respective device depending on the current use case or user situation.

A source perpendicular to such detector will collect maximum light on its diffuser/aperture size. A tilt between source and detector generates less light on the same diffuser/aperture size. The absolute value of irradiance detection will decrease by a cosine function of the tilt angle. Wearables or handheld devices during use will tilt anytime and the accuracy for instance for Lux measurement will provide wrong or erroneous output values.

Further, depending on the performance and potentially also on the design of an integrated diffuser, the system accuracy in particular is also depending on the position of a dominant radiation spot or light source. A wide diffused object will scatter the light more homogeneously into the inside of the detector array 36 than a dominant and small point-type light source. Typically, each diffuser with a common transmittance ratio has also an ideal Lambertian spread and will also vary the power distribution depending on the position (tilt vs. detector) and spectral sensitivity.

However, such diffusers typically used to generate a reliable, always similar angular distribution to compensate for the main disadvantages of interference filters, namely the angular depending transmission, cause additional design and production costs, and as mentioned the different orientation or tilt of the sensor 16 can produce a cosine error in radiation value.

In order to overcome these potential deficiencies and to provide a multispectral functional sensor unit 10 with improved performance, at superior cost level, in accordance with an aspect of the present invention, the camera system 1 in the embodiment shown is provided with means for compensation of such radiance distribution and for improved spectral reconstruction even if no diffuser is provided for the multispectral functional sensor unit 10, or if the diffuser is designed with other goals of optimization. In order to achieve such compensation and improvement, in an embodiment of the present invention the camera system 1 is designed and arranged for the generation of a parameter characteristic for an angle of incidence (AOI) of the irradiance of the camera system 1 or of the measured ambient light in the ambient light sensor 4. In accordance with one aspect of the invention, this parameter is provided in combination with the multispectral sensor system 10 in order to provide compensation for changes of irradiating lux values as a consequence of varying tilt angles of the respective device, and in particular to compensate cosine error effects at tilted use cases for ambient colour and spectral sensing in the multispectral detector unit 10, and/or to potentially be able to replace a diffuser entirely or at least in part by providing mathematical correction of the spectral sensor signals by an improved spectral reconstruction matrix instead.

According to an aspect of the invention, this concept is achieved by a proper and appropriate design of the camera sensor unit 2 of the camera system 1. Thus, in accordance with one aspect of the invention, the camera image is used to estimate the angle of incidence (AOI) of the incoming light and use this AOI information to improve the calibration of the ambient light sensor 4.

As shown in FIG. 1, in simplified form in order to explain the basic concept of the present invention, the camera sensor unit 2 may be designed in the general form of a sensor chip. The camera sensor unit 2 comprises a housing 50 with a sensor chamber 52 in which the optical camera sensor 54 is positioned. On top of the camera sensor 54, and in the direction towards incoming light, an optical system is provided, symbolized in FIG. 1 by lens 56.

The housing 50 of the camera sensor unit 2 is arranged on a substrate or carrier 58. The carrier or substrate 58 provides mechanical support and electrical connectivity to electronic components which are integrated into the camera sensor unit 2. For example, the carrier 58 may comprise a printed circuit board, PCB (not shown). However, in other embodiments (not shown) the carrier 58 can also be part of the housing 50, and electronic components may be embedded into the housing 50 by molding for example. In yet an alternative embodiment, the circuitry may be designed in TSV technology (“through silicon via”). A through-chip via is a vertical electrical connection (via) that passes completely through a silicon wafer or die. The contacting of the chip in this technology is brought to the backside of the chip and processed as a BGA (ball grid array). The advantage is that everything may be mounted at wafer level (Si, filter, glass, optic, aperture, diffuser).

As part of the camera sensor unit 2, the optical camera sensor 54 is arranged inside the chamber 52 and on the carrier 58. In this particular embodiment, the camera sensor 54 is integrated into a single semiconductor sensor die 60 together with other electronics. The optical camera sensor 54 comprises an array 62 of individual camera sensor pixels 64. In other words, the digital camera unit 2 comprises an array 62 of sensors, and by means of this array 62 (in other words im-age), the spatial light distribution impacting the array 62 can be estimated. For example, it can be calculated which part of image is brighter than the others and from that it can be estimated where the light source is located and in this way, the AOI can be calculated. Once the AOI is known, the corresponding sensor response can be estimated based on mathematical methods such as transfer matrix method. In an aspect of the invention, possibly in addition to their other functionalities, the camera sensor pixels 64 each are designed to generate an irradiance sensor signal. In yet another aspect of the invention, these irradiance sensor signals generated by the camera sensor pixels 64 are provided for the generation of a parameter characteristic for an angle of incidence (AOI) of the irradiance of the camera sensor 54. This parameter may later be used for compensation or correction purposes for the signals generated by the multispectral sensor unit 10.

For this purpose, the optical camera sensor unit 2, in addition to the optical camera sensor 54, comprises a control unit 70, which with respect to data transfer and communication is connected with the optical camera sensor 54 and/or its control system if applicable, as symbolized by double arrow 72. The control unit 70 is arranged to calculate the parameter characteristic for the angle of incidence (AOI) of the irradiance of the camera sensor 54 from irradiance sensor signals generated by at least some of the camera sensor pixels 64. Accordingly, in a general aspect of the present invention considered independently inventive, the camera sensor unit 2 is enabled and intended to be used to determine information or a parameter characteristic for the AOI of the camera sensor 54, possibly in addition to other use cases for the camera sensor unit 2.

In the embodiment shown, the control unit 70 further with respect to data transfer and communication is connected with the optical multispectral functional sensor 16 and/or its control system if applicable. It is noted that in the embodiment shown, control unit 70 is provided as a separate component, but of course it may as well be integrated with the control system of the camera sensor 54 and/or the control System of the multispectral sensor 16.

In consequence, in one aspect of the invention and in the embodiment shown, the camera system 1 comprises the camera sensor unit 2, the functional sensor unit 10 featuring the ambient light sensor 4, and the control unit 70, wherein the control unit 70 is arranged to calculate a compensation parameter for each of the functional sensor pixels 38 from irradiance sensor signals generated by at least some of said camera sensor pixels 64. In a further aspect of the invention the control unit 70 further is arranged to modify the multispectral sensor signal generated by each of the functional sensor pixels 38 by the compensation parameter calculated for the respective pixel 38 to obtain a compensated multispectral sensor signal for each functional sensor pixel 38.

In the embodiment shown in FIG. 1, in order to optimize efficiency and to minimize costs, no diffuser is provided for the optical multispectral functional sensor 16; instead, compensation of errors is provided by the compensation concept described above. In other embodiments, however, the camera system 1 may nevertheless comprise a diffuser arranged on top of the aperture 18 on the housing 12. This diffuser may be optimized with respect to individual requirements of the respective use case, whereas supreme light scattering properties in view of the compensation concept described above are not of high priority.

In operation of the camera system 1, the method for multi-spectral light sensing comprises the step of calculating the compensation parameter for each of the functional sensor pixels 38 from irradiance sensor signals generated by at least some of said camera sensor pixels 64. It further comprises the step of modifying the multispectral sensor signal generated by each of the functional sensor pixels 38 by the compensation parameter calculated for the respective pixel 38, and providing the modified multispectral sensor signals as output signals of the functional sensor unit 10. The method of operation, as may be implemented in appropriate software or control modules, therefore includes the steps of obtaining raw data from the elements of the ambient light sensor 4, obtaining data allowing an estimation of the AOI from the camera sensor 54, and combining these data to obtain improved calibration or interpretation of the sensor raw data in order to provide improved sensor output signals for the ambient light sensor 4.

The embodiments of the camera system 1 discussed herein have been disclosed for the purpose of familiarizing the reader with novel aspects of the idea. Although preferred embodiments have been shown and described, many changes, modifications, equivalents and substitutions of the disclosed concepts may be made by one having skill in the art without un-necessarily departing from the scope of the claims.

In particular, the disclosure is not limited to the disclosed embodiments, and gives examples of as many alternatives as possible for the features included in the embodiments discussed. However, it is intended that any modifications, equivalents and substitutions of the disclosed concepts be included within the scope of the claims which are appended hereto.

Features recited in separate dependent claims may be advantageously combined. Moreover, reference signs used in the claims are not limited to be construed as limiting the scope of the claims.

Furthermore, as used herein, the term “comprising” does not exclude other elements. In addition, as used herein, the article “a” is intended to include one or more than one component or element, and is not limited to be construed as meaning only one.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

### LIST OF REFERENCE NUMERALS

1 camera system
2 camera sensor unit
4 ambient light sensor
6 cover glass
10 functional sensor unit
12 housing
14 chamber
16 optical multispectral functional sensor
18 aperture
24, 26 cone
28 radiation pattern
30 substrate
32 lid
34 sensor die
36 array
38 pixel
40 array
42 optical filter
44 channel
50 Housing
52 sensor chamber
54 optical camera sensor
56 lens
58 substrate
60 sensor die
62 array
64 camera sensor pixel
70 control unit
72, 74 double arrow

1. A camera system, comprising:
a camera sensor unit having an optical camera sensor, wherein the optical camera sensor comprises an array of camera sensor pixels, each generating an irradiance sensor signal, wherein the irradiance sensor signals generated by the camera sensor pixels are provided for generation of a parameter characteristic for an angle of incidence (AOI) of the irradiance of the camera sensor;
a functional sensor unit having an optical multispectral functional sensor, wherein the optical multispectral functional sensor comprises an array of functional sensor pixels, wherein the functional sensor pixels each have a different spectral transmission characteristic, each generating a multispectral sensor signal, respectively; and
a control unit arranged to:
calculate the parameter characteristic for the AOI of the irradiance of the camera sensor from the irradiance sensor signals generated by at least some of the camera sensor pixels; and
calculate a compensation parameter for each of the functional sensor pixels from irradiance sensor signals generated by at least some of said camera sensor pixels.

2. (canceled)

3. (canceled)

4. The camera system of claim 1, wherein the control unit further is arranged to modify the multispectral sensor signal generated by each of the functional sensor pixels by the compensation parameter calculated for the respective pixel to obtain a compensated multispectral sensor signal for each functional sensor pixel.

5. The camera system of claim 1, further comprising a diffuser arranged on top of an aperture on a housing with a chamber, in which said functional sensor is arranged.

6. The camera system of claim 1, wherein at least the functional sensor pixels each comprise a photodiode and a filter, wherein the filter determines the spectral transmission characteristic of the respective sensor pixel.

7. (canceled)

8. The camera system claim 1, in which the functional sensor unit is designed as an Ambient Light Sensor.

9. A method for multispectral light sensing, comprising:
detecting received photons by an optical camera sensor, wherein the optical camera sensor comprises an array of camera sensor pixels;
generating an irradiance sensor signal for each camera sensor pixel;
detecting received photons by an optical multispectral functional sensor, wherein the optical multispectral functional sensor comprises an array of functional sensor pixels each having a different spectral transmission characteristic,
generating a multispectral sensor signal for each functional sensor pixel; and
calculating a compensation parameter for each of the functional sensor pixels from irradiance sensor signals generated by at least some of said camera sensor pixels.

10. The method of claim 9, further comprising:
modifying the multispectral sensor signal generated by each of the functional sensor pixels by the compensation parameter calculated for the respective pixel; and
providing the modified multispectral sensor signals as output signals of a functional sensor unit.

11. The method of claim 9, further comprising generating a parameter characteristic for an angle of incidence (AOI) of the irradiance of the camera sensor from the irradiance sensor signals generated by the camera sensor pixels.

12. Use of the method of claim 9 in an application for ambient light sensing.
